(19) United States
(12) Patent Application Publication
(10) Pub. No.: US 2004/0264396 A1
(43) Pub. Date: Dec. 30, 2004

(54) Method for power saving in a wireless LAN

(76) Inventors: Boris Ginzburg, Haifa (IL); Oren Kaidar, Givat Ada (IL); Vladimir Kondratiev, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/608,143

(22) Filed: Jun. 30, 2003

(51) Int. Cl. G08C 17/00

(52) U.S. Cl. 370/311

(57) ABSTRACT

A method, apparatus and system are disclosed for power saving in a wireless local area network (WLAN), for example, by buffering data packets until a transmission or wake-up trigger occurs, at which time all buffered data packets may be transmitted.

### BACKGROUND OF THE INVENTION

The power consumed by mobile units may be an important factor in designing systems and devices of a wireless communication network, for example, a Wireless Local Area Network (“WLAN”).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a simplified schematic illustration of two wireless devices communicating through a link of a wireless communication system in accordance with an embodiment of the present invention;

FIG. 2 is a schematic timeline illustration demonstrating transmission and reception of data in a WLAN according to exemplary embodiments of the present invention; and

FIG. 3 is a schematic block diagram of a method of power saving in a WLAN according to exemplary embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity or several physical components included in one functional block or element. Further, where considered appropriate, reference numerals may be repeated among the figures to indicate corresponding or analogous elements. Moreover, some of the blocks depicted in the figures may be combined into a single function.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic quantities within the computing system's registers and/or memories into other data similarly represented as physical quantities within the computing system's memories; registers or other such information storage, transmission or display devices. In addition, the term “plurality” may be used throughout the specification to describe two or more components, devices, elements, parameters and the like.

It should be understood that the present invention may be used in a variety of applications. Although the present invention is not limited in this respect, the circuits and techniques disclosed herein may be used in many apparatuses such as units of an wired network for example, local area network (LAN) and/or wireless communication system, such as for example, a WLAN communication system and/or in any other unit and/or device in which power saving may be desirable. Units of WLAN communication system intended to be included within the scope of the present invention include, by way of example only, mobile units (MU), access points (AP), wireless receivers, and the like.

Types of WLAN communication systems intended to be within the scope of the present invention include, although are not limited to, “IEEE-Std 802.11, 1999 Edition (ISO/IEC 8802-11: 1999)” standard, and more particularly in “IEEE-Std 802.11b-1999 Supplement to 802.11-1999, Wireless LAN MAC and PHY specifications: Higher speed Physical Layer (PHY) extension in the 2.4 GHz band”, “IEEE-Std 802.11a-1999, Higher speed Physical Layer (PHY) extension in the 5 GHz band” standard, and the like.

Although the scope of the present invention is not limited in this respect, the circuits and techniques disclosed herein may also be used in units of a cellular communication systems, digital communication systems, satellite communication systems and the like. Types of cellular radiotelephone receivers intended to be within the scope of the present invention include, although not limited to, Code Division Multiple Access (CDMA), CDMA 2000 and wideband CDMA (WCDMA) cellular radiotelephone, receivers for receiving spread spectrum signals, and the like.

Devices, systems and methods incorporating aspects of embodiments of the invention are also suitable for computer communication network applications, for example, intranet and Internet applications. Embodiments of the invention may be implemented in conjunction with hardware and/or software adapted to interact with a computer communication network, for example, a local area network (LAN), wide area network (WAN), or a global communication network, for example, the Internet.

In an exemplary embodiment of the invention, certain packets intended for transmission, for example, low priority or no priority packets, may be buffered and stored for transmission as a group. In this way, a transmitting unit may transmit more content during certain transmission slots while increasing the number of transmission slots in which the transmitting unit may shut down or operate in a “power-save” mode of operation.

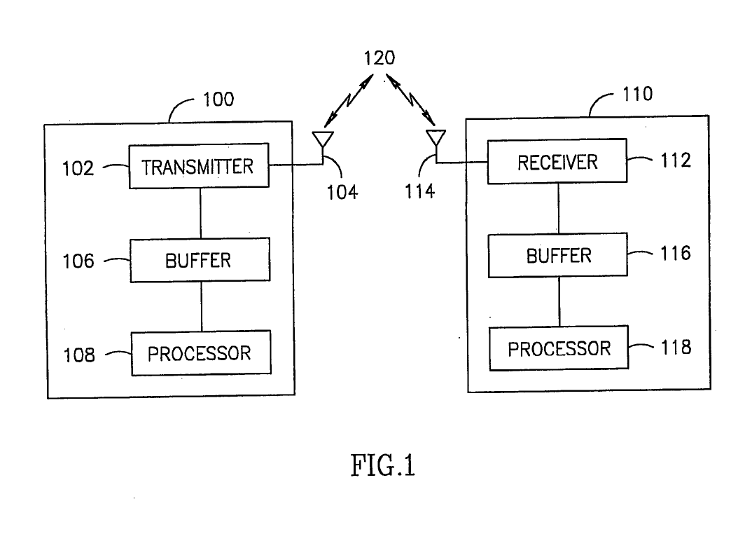

Reference is made to FIG. 1, which schematically illustrates two wireless devices, 100 and 110, communicating via a wireless link or channel 120 of a wireless communication system in accordance with embodiments of the present invention. Although the scope of the present invention is not limited in this respect, communication devices 100 and 110 may comprise wire or wireless or cable modems of computers and communication channel 120 may be part of a wide-area-network (WAN) or a LAN. For example, the system may be a WLAN system or a digital subscriber line (DSL) system. Alternatively, although the scope of the present invention is not limited in this respect, the communication system shown in FIG. I may be part of a cellular communication system, with one of communication devices 100, 110 being a base station or unit and the other a mobile station or unit. Alternatively, both communication devices 100 and 110 may be mobile stations, a pager communication system, a personal digital assistant (PDA) and a server, etc. In the case of a cellular wireless communication system, according to some embodiments of the invention, the communication system shown in FIG. 1 may be a 3^{rd} Generation Partnership Project (3GPP), such as, for example, Frequency Domain Duplexing (FDD), Wideband Code Division Multiple Access (WCDMA) cellular system and the like.

Communication device 100 may include a transmitter 102. Communication device 110 may include a receiver 112. Transmitter 102 may include any suitable transmission and/or reception circuitry known in the art and may be implemented, for example, in the form of a single unit or in the form of separate transmitter and receiver units using any suitable combination of hardware and/or software as is known in the art. In such cases, although the scope of the present invention is in no way limited in this respect, communication devices 100 and 110 may each comprise a radio frequency antenna, 104 and 114, respectively, as is known in the art. Antennas 104 and 114 may be any suitable antenna known in the art, for example, a dipole antenna, an omni-directional antenna or any other suitable RF antenna. In some exemplary embodiments, communication devices 100 and 110 may contain a broadband processor or other suitable processor (not shown) to accept data and prepare it for transmission via the antenna. Such a processor may be implemented in software or hardware using methods and components known in the art.

Wireless device 100 may include a processor 108, which may be connected to a memory (not shown). According to embodiments of the present invention, processor 108 may send data packets to a buffer 106, where the data packets may be stored until a condition for transmission is fulfilled or a trigger for transmission according to exemplary embodiments of the invention occurs. Upon the fulfillment of such a condition or trigger, the data packets may be sent to a transmitter 102, which may include a transmitter to transmit the data packets via an antenna 104.

Wireless device 110 may include a processor 118, which may be connected to a memory (not shown), and a receiver 112, which may include any suitable transmission and reception circuitry as is known in the art. In accordance with exemplary embodiments of the present invention, wireless device 110 may receive data packets transmitted by wireless device 100 via an antenna 114, which may be similar to antenna 104, and a receiver of receiver 112, which may send the data packets to processor 118 for processing. As further described below, in some embodiments of the present invention, wireless unit 110 may also transmit data packets to wireless unit 100, for example, where unit 100 is a remote unit and unit 110 is a base unit. In such cases, according to some embodiments of the present invention, wireless unit 110 may also include a buffer 114 to store data packets for transmission to wireless unit 100.

It will be appreciated by those skilled in the art that the simplified components schematically illustrated in FIG. 1 are intended for demonstration purposes only, and that other components may be required for operation of the wireless devices. Those of skill in the art will further note that the connection between components in a wireless device need not necessarily be exactly as depicted in the schematic diagram.

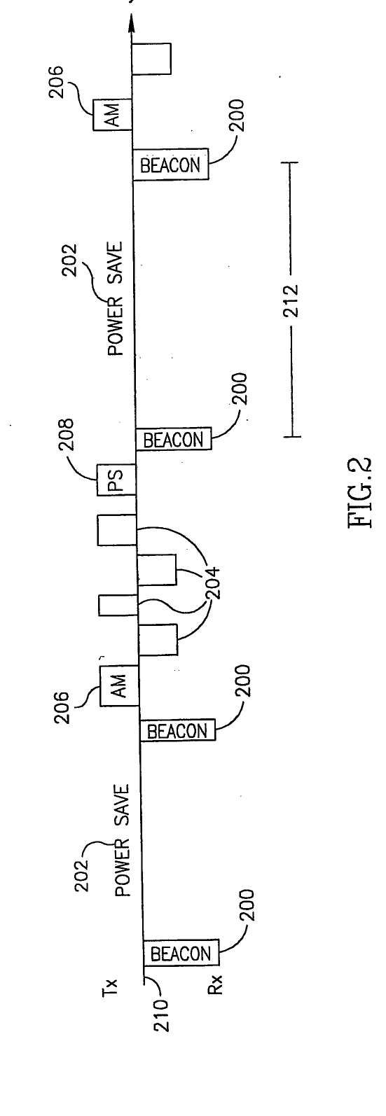

Reference is made to FIG. 2, which schematically depicts a sequence of transmissions and receptions according to exemplary embodiments of the invention by wireless devices in wireless communication, for example, units 100 and 110 of FIG. 1, which may be in a WLAN configuration. For purposes of the following discussion, an embodiment of the present invention is described having a remote unit and a base unit, and wherein the power of the remote unit is conserved. However, it will be appreciated that the present invention is applicable to any wireless devices in wireless communication.

The portion shown above a timeline 210 in FIG. 2 represents a sequence of transmissions by a remote wireless unit, whereas the portion below timeline 210 represents a sequence of receptions by the remote unit. Beacons 200 transmitted by a base unit delineate the beginnings and endings of transmission slots, corresponding to time periods during which the remote unit may receive or send data packets. As shown, in some of the transmission slots, the remote unit may be in a “power save” mode, which may be in effect during power save intervals 202, during which no data packets are sent or received by the remote unit. During power save mode, the transceiver may be disabled or shut off, for example, by turning off its clock or disconnecting its power. Such a disabling unit may be separate unit or integrated into another unit, such as a processor. In other transmission intervals, the unit may be in an “awake” mode, wherein the remote unit may transmit and receive data packets 204, for example, packets that have been buffered by the remote unit during the power save mode. In the embodiment shown, a remote unit may indicate that it is emerging from power save mode, for example, by way of an awake mode (AM) signal 206, and it may indicate that it is entering power save mode by way of a power save (PS) signal 208. Similarly, the base unit may buffer data packets intended for transmission to the remote unit while the remote unit is in sleep mode and transmit them when the remote unit indicates that it has emerged from sleep mode.

According to embodiments of the present invention, a transmission sequence of the communication system as described above may ensure that the AM signal is the first signal transmitted after a last received beacon, and that the PS signal is the last signal transmitted before a next received beacon, as demonstrated in FIG. 2. In this manner, units in accordance with embodiments of the present invention may enter power save mode between beacons, automatically notifying other units, for example, a base unit, to accumulate packets scheduled to be sent until the unit emerges from the power save mode to the awake mode. It will be understood by those of skill in the art that the awake mode may span several slots and that a unit need not transmit an AM and a PS signal in every slot. In some exemplary embodiments, where a unit sends an AM signal at the start of a slot, a base unit may assume that the remote unit remains awake until it sends a PS signal. Likewise, in some exemplary embodiments, where a unit sends a PS signal at the end of a slot, a base unit may assume that the remote unit remains in power save mode until it sends an AM signal.

In some exemplary embodiments of the present invention, intended outgoing transmissions having certain priority criteria, for example, low priority or no priority, may be buffered until a wake-up trigger is reached, for example, as described below. The priority data for each packet may be assigned, for example, by the application producing the packet. For example, file transfer protocol (FTP) or Internet activity may produce large sized packets with low priority to be transmitted at large intervals. These may be buffered and sent as a group when the trigger is reached. During transmission intervals when no packets are sent, the unit may enter power save mode.

In some embodiments of the present invention, power save mode may be effected by disabling and/or disconnecting the transmission/reception sub-unit of a wireless unit, for example, by switching off power the power supply to all or part of the circuitry of transmitter 102 in FIG. 1 or by turning off the clock of the transceiver. The disabling unit may be a separate unit or integrated into another unit, such as a processor. The desired switching “on” or “off” transceiver circuitry and/or other circuits or sub-units associated with the reception and transmission functions of the wireless units may be executed using any method known in the art. According to xemplary embodiments of the invention, when the remote unit enters power save mode, a timer may be set to wake the transceiver in a predetermined period of time in order to receive the next beacon. Upon emergence from power save mode, the wireless unit may wait to receive the next beacon signal containing a Delivery Traffic Indication Message (DTIM), indicating that the AP has data to transmit to the remote unit before transmitting an AM signal and resuming transmission and/or reception activity. Alternately, the remote unit may emerge from power save mode at the initiative of the processor in order to transmit accumulated data.

The wake-up trigger for emerging from power save mode and initiating transmission and reception of the accumulated packets may be based on an event or condition, for example, reaching a threshold number of packets, a threshold size of aggregated packets, a threshold aggregated time of transmission for the buffered packets, etc. Alternatively, in some exemplary embodiments, the buffer may be emptied and the accumulated packets transmitted, even when a specific trigger or triggers indicating a full buffer are not present, in the event that no packets have been sent for transmission for a threshold period of waiting time. It will be recognized by those of skill in the art that other embodiments of the invention may use additional or alternative wake-up trigger events to determine when it would be desirable to empty the buffer and transmit the accumulated packets.

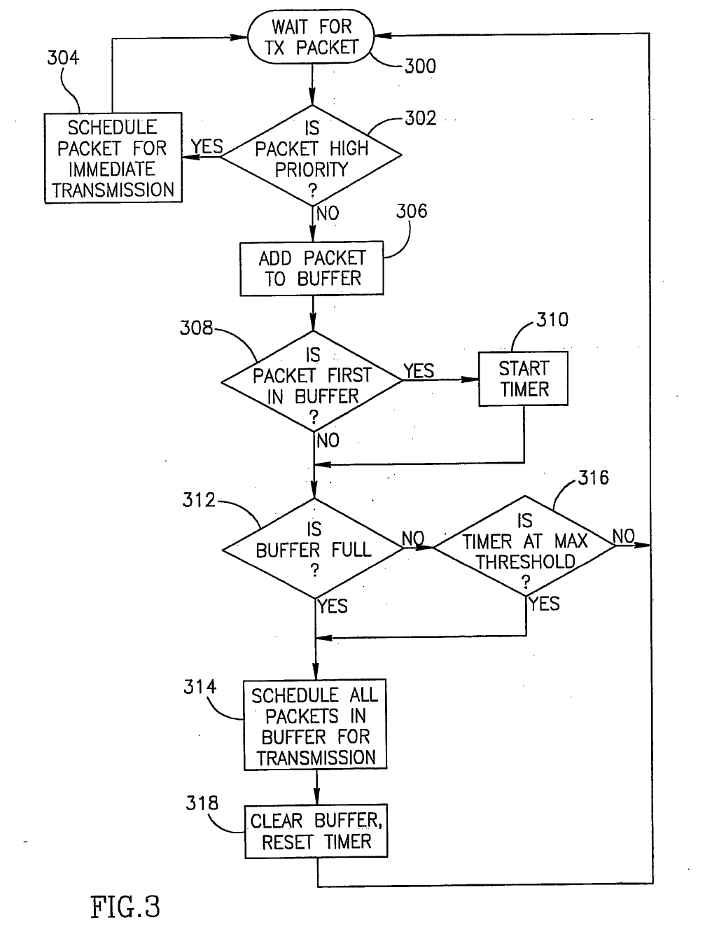

Reference is made to FIG. 3, which depicts a schematic block diagram of a method of transmitting in accordance with embodiments of the present invention. At block 300, transmitter may wait for the arrival of a packet containing data to be transmitted. As shown in decision block 302, when such packet arrives, the transmitting unit may determine whether the packet has high priority. If the packet is high priority, the packet may be scheduled for immediate transmission as shown in block 304. If the packet is not high priority, it may be added to a buffer as shown in block 306. If, as shown in block 308, the packet is the first to be placed in the buffer, or alternately, the buffer is empty before the packet is placed therein, a timer may be started as indicated at block 310. It may then be determined, as shown in block 312, whether the buffer is full. The buffer may be considered full according to a variety of criteria, for example, if a threshold number of packets is reached; a threshold size of aggregated packets is reached; a threshold aggregated time of transmission for the buffered packets is reached, etc. If the buffer is full, all buffered packets may be scheduled for transmission, as shown in block 314. Scheduling packets for transmission may include certain other actions, not shown, for example, sending an AM signal before the transmission and a PS signal after the transmission. Alternately, if the buffer is not full, it is determined whether the timer has exceeded a maximum threshold waiting time at block 316. If the threshold tim is reached, all buffered packets may be scheduled for transmission, as shown in block 314. If the timer is not above the threshold waiting time, the transmitter may continue to wait for new packets at block 300. After scheduling all buffered packets for transmission, the buffer may be cleared, the timer may be reset as indicated at block 318, and the transmitting unit may continue to wait for the arrival of new packets as indicated at block 300.

It will be recognized by those of skill in the art that embodiments of the present invention may, for example, be used for transmission by either a remote unit or a base station of a wireless communication network, e.g., a WLAN. The base station, for example, may buffer packets in order to save power at the receiver. In addition, those skilled in the art will recognize that the method according to embodiments of present invention may be performed using any suitable software or dedicated hardware or any suitable combination of hardware and/or software, in accordance with specific implementations and/or design requirements. For example, embodiments of the present invention may buffer the accumulated packets in a driver or card in operative communication with a remote unit seeking to transmit packets to and/or receive packets from a base station.

While the invention has been described with respect to a limited number of embodiments, it will be appreciated that many variations, modifications and other applications of the invention may be made. Embodiments of the present invention may include other apparatuses for performing the operations herein. Such apparatuses may integrate the elements discussed, or may comprise alternative components to carry out the same purpose. It will be appreciated by persons skilled in the art that the appended claims are intended to cover all such modifications and changes as fall within the true spirit of the invention.

What is claimed is:

1. A method comprising:
transmitting during an awake mode one or more data packets sent for transmission during a power save mode.

2. The method of claim 1, further comprising buffering said one or more data packets during said power save mode.

3. The method of claim 2, wherein transmitting during an awake mode comprises transmitting said one or more packets in response to a wake-up trigger.

4. The method of claim 3, wherein said wake-up trigger relates to an aggregate anticipated transmission time of the one or more data packets.

5. The method of claim 3, wherein said wake-up trigger relates to an aggregate size of the one or more data packets.

6. The method of claim 3, wherein said wake-up trigger relates to a period of time during which no data packets are sent for transmission.

7. The method of claim 2, wherein buffering comprises buffering one or more of said data packets based on a priority criterion.

8. The method of claim 7, wherein transmitting comprising transmitting said one or more data packets based on said priority criterion.

9. The method of claim 8, wherein said priority criterion relates to the priority of said one or more data packets.

10. The method of claim 1, wherein transmitting during an awake mode comprises transmitting an awake mode signal to indicate a start of said awake mode.

11. The method of claim 1, wherein transmitting during an awake mode comprises transmitting a power save signal to indicate an end of said awake mode.

12. The method of claim 1, comprising disabling a transmitter during said power save mode.

13. A program storage device having instructions readable by a machine that when executed by the machine result in:
transmitting during an awake mode one or more data packets sent for transmission during a power save mode.

14. The program storage device of claim 13, wherein said instructions further result in buffering said one or more data packets during said power save mode.

15. The program storage device of claim 14, wherein the instructions that result in transmitting during an awake mode comprise instructions that result in transmitting said one or more packets in response to a wake-up trigger.

16. The program storage device of claim 15, wherein said wake-up trigger relates to an aggregate anticipated transmission time of the one or more data packets.

17. The program storage device of claim 15, wherein said wake-up trigger relates to an aggregate size of the one or more data packets.

18. The program storage device of claim 15, wherein said wake-up trigger relates to a period of time during which no data packets are sent for transmission.

19. The program storage device of claim 14, wherein the instructions that result in buffering comprise instructions that result in buffering one or more of said data packets based on a priority criterion.

20. The program storage device of claim 19, wherein the instructions that result in transmitting during an awake mode comprise instructions that result in transmitting said one or more data packets based on said priority criterion.

21. The program storage device of claim 20, wherein said priority criterion relates to the priority of said one or more data packets.

22. The program storage-device-of claim 13, wherein the instructions that result in transmitting during an awake mode comprise instructions that result in transmitting an awake mode signal to indicate a start of said awake mode.

23. The program storage device of claim 13, wherein the instructions that result in transmitting during an awake mode comprise instructions that result in transmitting a power save signal to indicate an end of said awake mode.

24. The program storage device of claim 13, wherein the instructions result in disabling a transmitter during said power save mode.

25. An apparatus comprising a buffer to store one or more data packets during a power save mode and to transmit said one or more data packets during an awake mode.

26. The apparatus of claim 25, further comprising a processor adapted to transmit an awake signal to indicate a start of said awake mode.

27. The apparatus of claim 26, wherein said processor is further adapted to transmit a power save signal to indicate an end of said awake mode.

28. The apparatus of claim 27, comprising a disabling unit to disable said transmitter during said power save mode.

29. The apparatus of claim 28, wherein said disabling unit is able to enable said transmitter during said power save mode.

30. A wireless communication device comprising:
a buffer to store one or more data packets during a power save mode;
a transmitter adapted to transmit said at least one data packet during an awake mode; and
an omni-directional antenna operationally coupled to said transceiver.

31. The wireless communication device of claim 30, further comprising a processor to produce said one or more data packets.

32. The wireless communication device of claim 31, wherein said transmitter is further adapted to transmit an awake mode signal to indicate a start of said awake mode.

33. The wireless communication device of claim 31, wherein said transmitter is further adapted to transmit a power save mode signal to indicate an end of said awake mode.

34. The wireless communication device of claim 31, further comprising a power source and circuitry to connect said transmitter to said power source during said awake mode.

35. The wireless communication device of claim 35, further comprising circuitry to disconnect said transmitter from said power source during a power save mode.

36. A wireless communication system comprising:
a first wireless device adapted to transmit during an awake mode one or more data packets sent for transmission during a power save mode; and
a second wireless device adapted to receive said one or more data packets.

37. The wireless communication system of claim 36, wherein said second wireless device is further adapted to transmit during said awake mode one or more data packets sent for transmission during said power save mode.

38. The wireless communication system of claim 37, wherein said first wireless device is further adapted to transmit an awake mode signal to indicate a start of said awake mode.

39. The wireless communication system of claim 38, wherein said first wireless device is further adapted to transmit a power wave mode signal to indicate an end of said awake mode.
